(19) United States
(12) Patent Application Publication
(10) Pub. No.: US 2020/0254836 A1
(43) Pub. Date: Aug. 13, 2020

(54) TRAILER COUPLER GUARD

(71) Applicants: Lee H. Bridgman, JR., North Pole, AK (US); Connie J. Bridgman, North Pole, AK (US)

(72) Inventors: Lee H. Bridgman, JR., North Pole, AK (US); Connie J. Bridgman, North Pole, AK (US)

(21) Appl. No.: 16/788,907

(22) Filed: Feb. 12, 2020

Related U.S. Application Data
(60) Provisional application No. 62/918,769, filed on Feb. 12, 2019.

(51) Int. Cl. B60D 1/60; B60D 1/58

(52) U.S. Cl. CPC B60D 1/60; B60D 1/583

(57) ABSTRACT

A guard for protecting a trailer coupler and any associated components (such as a lock or an electrical connector) from elements such as rain, dust, dirt, snow and ice when the trailer is in storage and exposed to the elements. The guard is made from waterproof fabric or film configured into a bag shape having an open mouth comprising a cut so that the guard can be slid over and around a trailer coupler and then the mouth of the guard closed around and secured to the trailer coupler to protect the trailer coupler and any associated components from elements such as rain, dust, dirt, snow and ice when the trailer is in storage and exposed to the elements.

### CROSS-REFERENCE TO RELATED APPLICATION

This application claims the benefit of U.S. Provisional Application No. 62/918,769, filed Feb. 12, 2019, and which is hereby incorporated by reference in its entirety.

### TECHNICAL FIELD

This disclosure relates to trailer couplers, coupler locks, and trailer electrical connectors.

### BACKGROUND

Trailers include couplers at which the trailer is connectable to a vehicle such as a car or truck. When a trailer is not attached to a vehicle, such as when the trailer is in storage, the coupler may be exposed to the elements. Rain, dust, dirt, snow and ice can cause multiple failures of a trailer coupler, a coupler lock or a trailer electrical connector. Rain, dust, dirt, snow and ice can cause the lock to fail or even the coupler latch to fail to operate requiring repair or replacement of the coupler and lock. If the lock rusts and will not unlock the key may well break off in the lock requiring the destruction of the lock or the services of a locksmith. If the coupler comprises electrical connectors for the trailer lights or trailer brakes, then rain, dust, dirt, snow and ice can cause electrical failures requiring repair.

### SUMMARY

A coupler guard is provided herein for the protection of trailer couplers, coupler locks and trailer electrical connectors from elements such as rain, dust, dirt, snow and ice when the trailer is in storage and exposed to the elements. The coupler guard is a waterproof bag-shaped guard that slides over the coupler with sufficient room to also protect electrical components if present. The coupler guard is cut at the opening to facilitate cuffing of the guard to a coupler.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, perspective view of a typical trailer coupler system at the distal end of the tongue of a trailer as well as the electrical connector and cable for the lights of the trailer;

FIG. 2 is a schematic, bottom view of a coupler guard in accordance with the claimed invention;

FIG. 3 is a schematic, side view of the coupler guard of FIG. 2 engaged with the trailer coupler system of FIG. 1; and

FIG. 4 is a schematic, perspective view of an alternative coupler guard.

### DESCRIPTION OF THE PREFERRED EMBODIMENTS

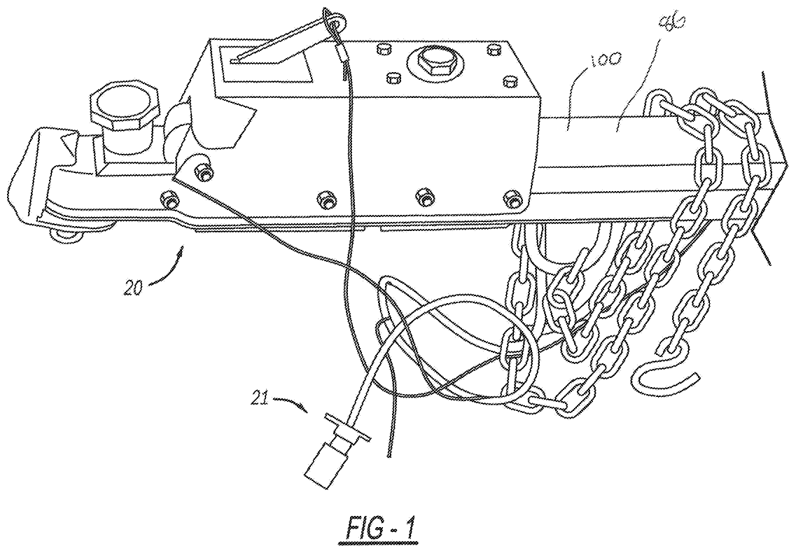

Referring now to FIG. 1, therein is shown a typical trailer coupler system 20 as well as the electrical connector 21 and cable for the lights of a trailer 100. Although FIG. 1 shows the trailer coupler system 20 for a boat trailer, it should be understood that the coupler guard described herein can be used with any trailer such as, and without limitation thereto, a utility trailer, an ATV trailer, an RV camper trailer or a heavy duty equipment trailer within the scope of the claimed invention.

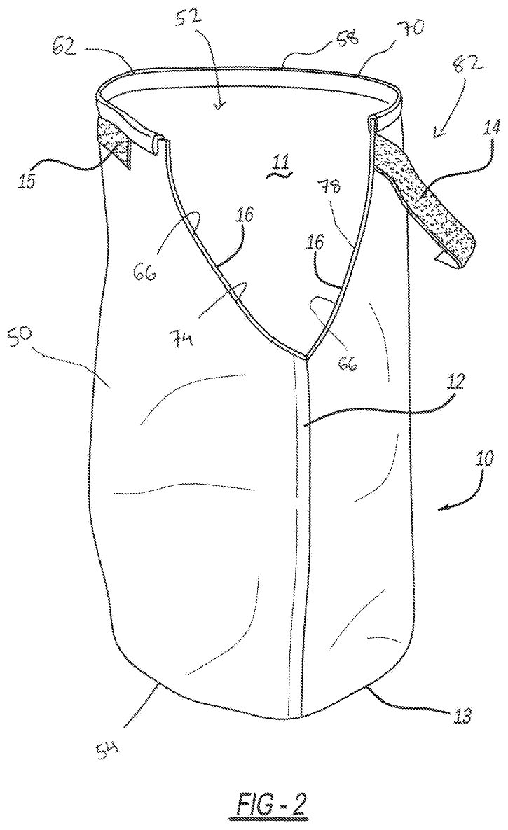

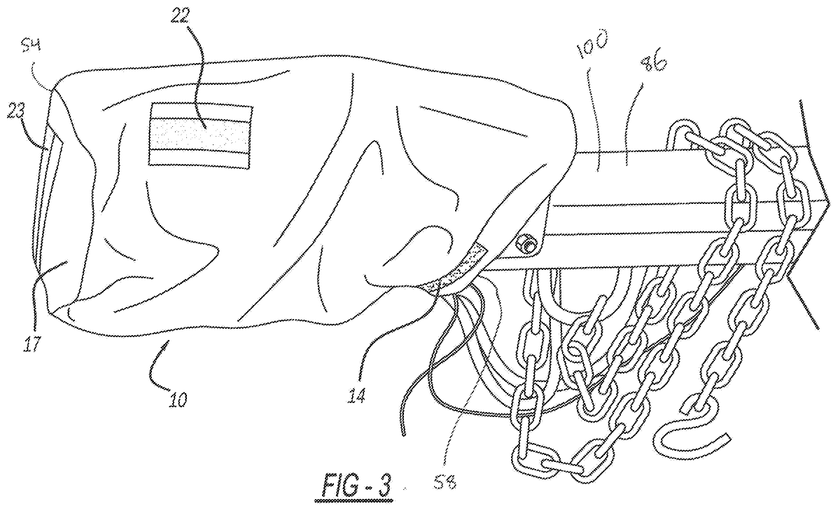

Referring now to FIG. 2, therein is shown a coupler guard 10. Guard 10 comprises a sheet of waterproof material 11 formed into a tubular shape by seam 12. Seam 13 attaches a disk of waterproof material (element 17 shown in FIG. 3) to one end of guard 10. The other end of guard 10 is open. Material 11 comprises V-cut 16 in the mouth of guard 10. Velcro strap 14 and Velcro strip 15 and V-cut 16 permit the mouth of guard 10 to close and be secured around the rear of a trailer coupler system as shown in FIG. 3. Referring still to FIG. 3, wherein like reference numbers refer to like components from FIGS. 1 and 2, guard 10 preferably comprises reflective strips 22 and 23.

Thus, and with reference to FIGS. 2 and 3, the coupler guard 10 comprises flexible material 11 forming a tube 50 having a first end 54 and a second end 58. The tube 50 formed by material 11 is generally cylindrical in the embodiment depicted. However, it should be noted that the tube may have other shapes within the scope of the claimed invention. The tube 50 defines a cavity 52. The first end 54 is closed by the disk 17 of waterproof material. The second end 58 defines a first opening 62 to the cavity 52. The material 11 defines a second opening 66 that is contiguous with the first opening 62 and that extends longitudinally with respect to the tube 50.

More specifically, the material 11 includes a first edge 70 at end 58 that defines the first opening 62. The material also defines a second edge 74 and a third edge 78. The second edge 74 and the third edge 78 extend longitudinally with respect to the tube 50. The second edge 74 and the third edge 78 cooperate with each other to define the second opening 66 therebetween. The second opening 66 in the embodiment depicted is generally V-shaped; however, the second opening 66 may have other shapes within the scope of the claimed invention, including, but not limited to, a U-shape.

The material 11 is sufficiently flexible such that the second and third edges 74, 78 are movable with respect to each other. Accordingly, the second and third edges 74, 78 can be brough together so that a cuff is formed at the first opening 62. The coupler guard 10 includes a fastening system 82 configured to releasably retain at least a portion of the second edge 74 with respect to at least a portion of the third edge 78 to maintain the cuff. The fastening system 82 is a hook and loop closure, i.e., Velcro strap and strip 14, 15.

The arrangement of the first and second openings 62, 66 enables the entry of the coupler system (shown at 20 in FIG. 1) and the electrical connector (shown at 21 in FIG. 1) into the cavity 52 through the openings 62, 66 while also providing an effective closure around the tongue (shown at 86 in FIG. 1) to limit or minimize the entry of snow, moisture, dust, etc. into the cavity 52. More specifically, the openings 62, 66 enable the formation of a cuff that fits tightly around the tongue 86 without bunching of the material 11.

A method of using the coupler guard 10 includes moving the coupler guard 10 so that the trailer coupler system 20 and the trailer electrical connector 21 enter the cavity 52 through the first opening 62, as shown in FIG. 3. Once the coupler system 20 and the connector 21 are in the cavity 52, the method includes cuffing and securing the first opening 62 of the coupler guard 10 around the trailer tongue 62. Cuffing and securing the first opening 62 includes drawing the second and third edges 74, 78 closer to each other and then engaging the fastening system 78.

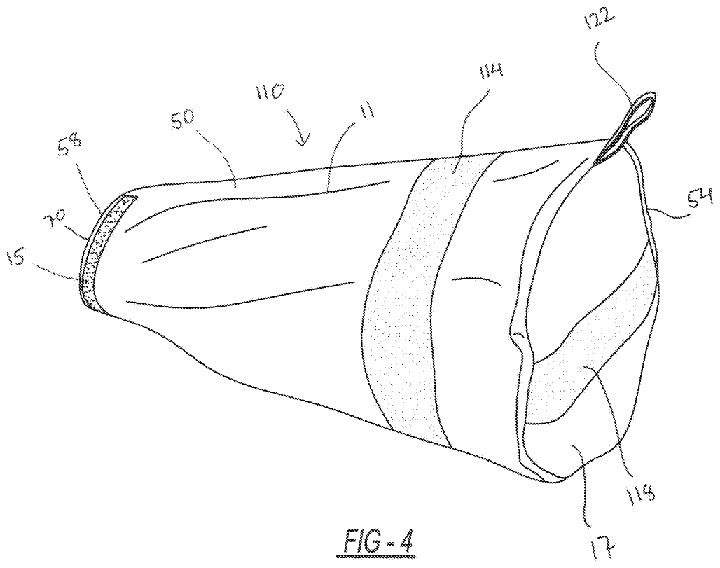

Referring to FIG. 4, wherein like reference numbers refer to like components from FIGS. 1-3, an alternative coupler guard 110 is schematically depicted. Coupler guard 110 is substantially identical to the coupler guard shown at 10 in FIGS. 2 and 3, except that coupler guard 110 includes reflectors attached thereto. The reflectors in the embodiment depicted include reflective strips 114, 118 stitched to the material 11. Reflective strip 114 encircles the tube 50, and reflective strip 118 extend across the disk 11 at end 54. A loop 122 is connected to the material 11 at end 54 and is configured to engage a coat hook in a vehicle. Accordingly, the coupler guard 110 may be hung from a coat hook in the vehicle when not in use, rather than on the seats or floor of the vehicle.

The components of the instant invention can be made of any suitable material and can be of any suitable dimension. A highly preferred guard of the instant invention comprises yellow or orange waterproof fabric or film finished by, for example, sewing the seams shown in FIG. 2. In one embodiment, the material 11 is “ripstop” Nylon. In another embodiment, the material 11 is 600 denier canvas with polyurethane backing. A highly preferred guard of the instant invention is nineteen inches long and ten inches in diameter. Although Velcro is the preferred fastening means to secure the open end of the guard onto a trailer coupler, it should be understood that any suitable means (such as a draw cord) can be used to secure the open end of the guard onto a trailer coupler. It should be understood that the cut in the mouth of the guard of the instant invention can be of any suitable shape such as, and without limitation thereto, a linear cut or a U shaped cut.

While the best modes for carrying out the invention have been described in detail, those familiar with the art to which this invention relates will recognize various alternative designs and embodiments for practicing the invention within the scope of the appended claims.

1. A coupler guard for protecting a trailer coupler system, the coupler guard comprising:
flexible material forming a tube having a first end and a second end;
said first end being closed;
said second end forming a first opening;
said material defining a second opening that is contiguous with the first opening and that extends longitudinally with respect to the tube.

2. The coupler guard of claim 1, wherein the material includes a first edge that defines the first opening, and a second and third edge that cooperate to define the second opening;
wherein the material is sufficiently flexible such that the second and third edges are movable with respect to each other; and
wherein the coupler guard further comprises a fastening system configured to releasably retain at least a portion of the second edge with respect to at least a portion of the third edge.

3. The coupler guard of claim 2, wherein the fastening system is a hook and loop closure system.

4. The coupler guard of claim 2, wherein the tube is generally cylindrical.

5. The coupler guard of claim 4, wherein the material is canvas with a polyurethane backing.

6. The coupler guard of claim 4, further comprising reflectors mounted to the material.

7. The coupler guard of claim 4, further comprising a loop mounted to the material and configured to engage with a coat hook in a vehicle.

8. A method for protecting a trailer coupler system from elements such as rain, dust, dirt, snow and ice when the trailer is in storage and exposed to the elements, the method comprising:
possessing a coupler guard having flexible material forming a tube having a first end and a second end and defining a cavity; said first end being closed; said second end forming a first opening; said material defining a second opening that is contiguous with the first opening and that extends longitudinally with respect to the tube;
moving the coupler guard so that the trailer coupler system enters the cavity through the first opening; and
cuffing and securing the first opening of the coupler guard.
